(19) United States
(12) Patent Application Publication
(10) Pub. No.: US 2025/0083893 A1
(43) Pub. Date: Mar. 13, 2025

(54) Quick-Attach Hopper Device

(71) Applicants: Bob Osbun, Highland Hills, OH (US); Matt Worthington, Highland Hills, OH (US)

(72) Inventors: Bob Osbun, Highland Hills, OH (US); Matt Worthington, Highland Hills, OH (US)

(21) Appl. No.: 18/406,444

(22) Filed: Jan. 8, 2024

Related U.S. Application Data
(60) Provisional application No. 63/581,144, filed on Sep. 7, 2023.

(51) Int. Cl. B65D 88/12; B65D 90/00; B65D 90/22

(52) U.S. Cl. CPC B65D 88/123; B65D 90/0033; B65D 90/22; B65D 2203/02; B66F 9/06

(57) ABSTRACT

A quick-attach hopper device is provided. The device is comprised of a quick-attach hopper device. The device provides a quick-attach hopper that can be attached to a skid steer. More specifically, the exterior surface of at least one side wall of the body is comprised of at least one skid steer quick-attach plate. The device may also be comprised of at least one fork pocket that also allows the device to be attached to a forklift or other forked machinery.

### CROSS-REFERENCE TO RELATED APPLICATION

The present application claims priority to, and the benefit of, U.S. Provisional Application No. 63/581,144, which was filed on Sep. 7, 2023, and is incorporated herein by reference in its entirety.

### FIELD OF THE INVENTION

The present invention relates generally to the field of hoppers. More specifically, the present invention relates to a quick-attach hopper device that provides a quick-attach hopper that can be attached to a skid steer and a piece of forked machinery. Accordingly, the present disclosure makes specific reference thereto. Nonetheless, it is to be appreciated that aspects of the present invention are also equally applicable to other like applications, devices, and methods of manufacture.

### BACKGROUND

Self-dumping hopper attachments have been engineered for use with forklifts, aligning with the distinct specifications and structure of these vehicles. However, they are not designed for compatibility with other machinery, especially machines like skid steers. When these attachments are misused with non-compatible machinery, several potential risks arise.

Firstly, the machinery or the hopper attachment itself may sustain damage due to mismatched connections. Secondly, there's an increased risk of unintentional release or spillage, which could potentially lead to both personal injuries and property damage. Thirdly, such mismatched pairings could result in unstable operations, possibly causing the machinery to tip over or the hopper to become imbalanced during lifting or dumping procedures. Fourthly, the machinery components might experience excessive wear and tear as they are not designed to accommodate the specific pressures and dynamics of the hopper.

Furthermore, using the hopper with inappropriate machinery could mean a breach of safety regulations or manufacturer's guidelines, which may lead to legal liabilities. Additionally, the efficiency and performance of both the machinery and the hopper could be severely compromised. Lastly, such misuse often leads to escalated maintenance and repair costs

Therefore, there exists a long-felt need in the art for an improved hopper attachment for machinery. There also exists a long-felt need in the art for a quick-attach hopper device. More specifically, there exists a long-felt need in the art for a quick-attach hopper device that provides a hopper that can be attached to a skid steer. There also exists a long-felt need in the art for a quick-attach hopper device that provides a hopper that can be attached to a skid steer and also a tractor.

The subject matter disclosed and claimed herein, in one embodiment thereof, comprises a quick-attach hopper device. The device is comprised of a quick-attach hopper device. The device provides a quick-attach hopper that can be attached to a skid steer. More specifically, the exterior surface of at least one side wall of the body is comprised of at least one skid steer quick-attach plate. The device may also be comprised of at least one fork pocket that also allows the device to be attached to a forklift or other forked machinery.

In this manner, the quick-attach hopper device of the present invention accomplishes all the foregoing objectives and provides an improved hopper attachment for machinery. More specifically, the device provides a hopper that can be attached to a skid steer. In addition, the device can also be attached to a tractor.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a quick-attach hopper device comprised of a hopper body comprised of an interior space, at least one pouring lip, and at least one quick-attach plate and/or fork pocket. The device is designed to attach to a piece of machinery such as, but not limited to a skid steer, a tractor, etc., wherein the device can be easily manipulated to receive and dump various styles of material.

The body is comprised of an interior space formed by at least three side walls, wherein the interior space may receive any type of material. The body may also have at least one curved pouring lip. The lip facilitates the transfer of material from the interior space to a machine, structure, location, etc., that the material is being dumped into/on to. Furthermore, a bottom wall of the body may be angled to facilitate easier transfer of material from the interior space.

The body may also be comprised of at least one fork pocket comprised of at least one opening that allows the fork of a piece of machinery to be placed through the pocket to allow the device to be attached to and transported by the piece of machinery. In another embodiment, the exterior surface is comprised of at least one quick-attach plate configured in the form of a skid steer quick-attach plate to allow a skid steer or tractor to easily attach to the body.

The present invention is also comprised of a method of using the device. First, a device is provided comprised of a hopper body comprised of an interior space formed by at least three side walls and a bottom wall, and at least one quick-attach plate. Then, the interior space can be filled with a material. Then, the device can be attached to a skid steer via attaching the skid steer to the quick-attach plate. Then, the device can be manipulated (i.e., raised, lowered, tilted, etc.) by the machinery until the body is tilted such that the material is dumped from the body into or onto a surface, structure, machine, area, etc.

Accordingly, the quick-attach hopper device of the present invention is particularly advantageous as it provides an improved hopper attachment for machinery. More specifically, the device provides a hopper that can be attached to a skid steer. In addition, the device can also be attached to the forklift or other forked machinery. In this manner, the quick-attach hopper device overcomes the limitations of existing machinery hoppers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a quick-attach hopper device of the present invention in accordance with the disclosed architecture;

FIG. 2 illustrates a rear perspective view of one potential embodiment of a quick-attach hopper device of the present invention in accordance with the disclosed architecture; and

FIG. 3 illustrates a flowchart of a method of using one potential embodiment of a quick-attach hopper device of the present invention in accordance with the disclosed architecture.

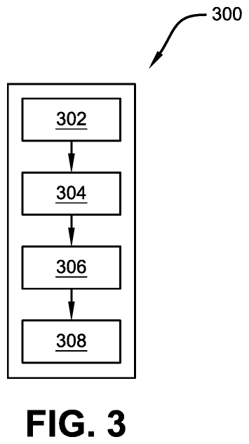

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved hopper attachment for machinery. There also exists a long-felt need in the art for a quick-attach hopper device. More specifically, there exists a long-felt need in the art for a quick-attach hopper device that provides a hopper that can be attached to a skid steer. There also exists a long-felt need in the art for a quick-attach hopper device that provides a hopper that can be attached to a skid steer and also a tractor.

The present invention, in one exemplary embodiment, is comprised of a quick-attach hopper device. The device is comprised of a hopper body comprised of an interior space, at least one pouring lip, and at least one quick-attach plate and/or fork pocket. During use, the device can attach to a piece of machinery such as, but not limited to, a skid steer, a tractor, etc., wherein the device can be easily manipulated to receive and dump various styles of material.

The body is comprised of an interior space formed by at least three side walls, wherein the interior space may receive any type of material. The body may also have at least one curved pouring lip that facilitates the transfer of material from the interior space to a machine, structure, location, etc., that the material is being dumped into/onto. Furthermore, a bottom wall of the body may be angled to facilitate easier transfer of material from the interior space.

The body may also be comprised of at least one fork pocket comprised of at least one opening that allows the fork of a piece of machinery to be placed through the pocket to allow the device to be attached to and transported by the piece of machinery. In another embodiment, the exterior surface is comprised of at least one quick-attach plate configured in the form of a skid steer quick-attach plate to allow a skid steer or tractor to easily attach to the body.

The present invention is also comprised of a method of using the device. First, a device is provided comprised of a hopper body comprised of an interior space formed by at least three side walls and a bottom wall, and at least one quick-attach plate. Then, the interior space can be filled with a material. Then, the device can be attached to a skid steer via attaching the skid steer to the quick-attach plate. Then, the device can be manipulated (i.e., raised, lowered, tilted, etc.) by the machinery until the body is tilted such that the material is dumped from the body into or onto a surface, structure, machine, area, etc.

Accordingly, the quick-attach hopper device of the present invention is particularly advantageous as it provides an improved hopper attachment for machinery. More specifically, the device provides a hopper that can be attached to a skid steer. In addition, the device can also be attached to the forklift or other forked machinery. In this manner, the quick-attach hopper device overcomes the limitations of existing machinery hoppers known in the art.

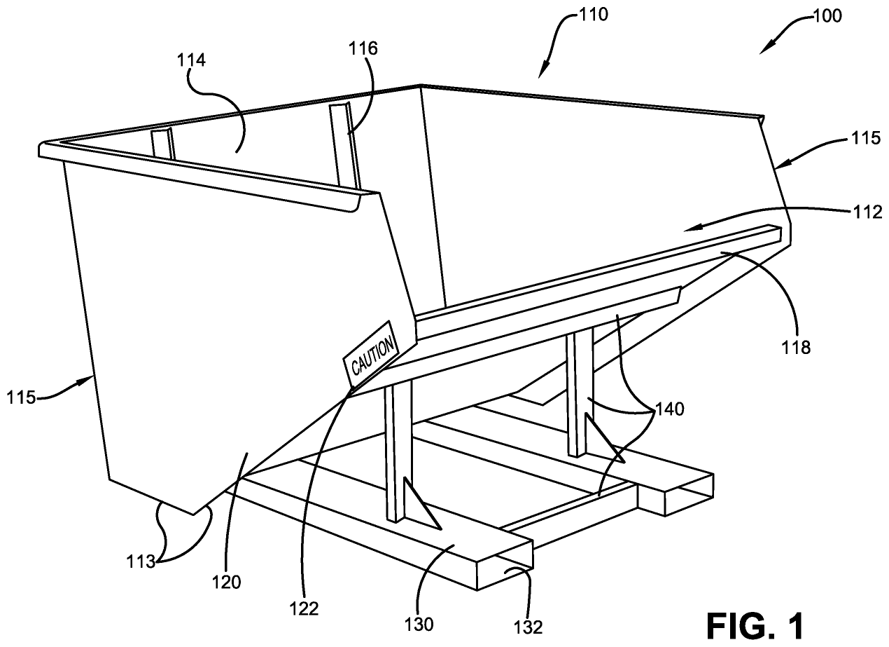

Referring initially to the drawings, FIG. 1 illustrates a front perspective view of one potential embodiment of a quick-attach hopper device 100 of the present invention in accordance with the disclosed architecture. The device 100 is comprised of a hopper body 110 comprised of an interior space 112, at least one pouring lip 118, and at least one quick-attach plate 124 and/or fork pocket 130. The device 100 is designed to attach to a piece of machinery such as, but not limited to, a skid steer, a tractor, etc., wherein the device 100 can be easily manipulated to receive and dump various styles of material.

The body 110 is comprised of an interior space 112 formed by at least three side walls 115. The interior space 112 may receive any type of material. Any area of the interior surface 114 of the body 110 may be comprised of at least one stiffening angle 116. The angle 116 increases the strength of the body 110. The body 110 may also have at least one curved pouring lip 118. The lip 118 facilitates the transfer of material from the interior space 112 to a machine, structure, location, etc., that the material is being dumped into/onto.

A bottom wall 113 of the body 110 may be angled. The wall 113 may form any angle between 0 and 180 agrees. In an embodiment wherein the bottom wall 113 is angled, the angle facilitates easier transfer of material from the interior space 112.

The body 110 may also be comprised of at least one fork pocket 130 comprised of at least one opening 132. The opening 132 allows the fork of a piece of machinery to be placed through the pocket 130 to allow the device 100 to be attached to and transported by the piece of machinery. The fork pocket 130 may strengthened and stabilized by at least one stiffening bracket 140 that attaches to the pocket 130 and body 110. The bracket 140 may be any vertical, horizontal, angled, and/or combination of bracket known in the art.

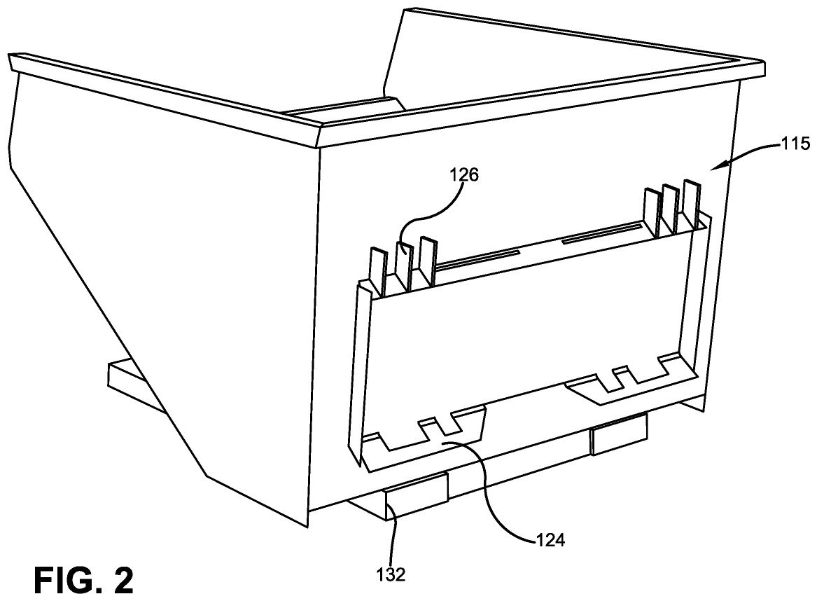

In another embodiment, the exterior surface 120 is also or alternatively comprised of at least one quick-attach plate 124, as seen in FIG. 2. The quick-attach plate 124 is preferably configured in the form of a skid steer and/or tractor quick-attach plate. In this manner, a skid steer can easily attach to the body 110. The plate 124 may be strengthened by at least one gusset 126.

The exterior surface 120 may also be comprised of at least one safety label of any type known in the art.

The present invention is also comprised of a method of using 300 the device 100, as seen in FIG. 4. First, a device 100 is provided comprised of a hopper body 110 comprised of an interior space 112 formed by at least three side walls 115 and a bottom wall 113, and at least one quick-attach plate 124 [Step 302]. Then, the interior space 112 can be filled with a material and the device 100 can be transported via a forklift by placing the forks of the forklift into at least one fork pocket 130 [Step 304]. Then, the device 100 can be attached to a skid steer or a tractor via attaching the skid steer or tractor to the quick-attach plate 124 [Step 306]. Then, the device 100 can be manipulated (i.e., raised, lowered, tilted, etc.) by the machinery until the body 110 is tilted such that the material is dumped from the body 110 into or onto a surface, structure, machine, area, etc. [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “quick-attach hopper device” and “device” are interchangeable and refer to the quick-attach hopper device 100 of the present invention.

Notwithstanding the foregoing, the quick-attach hopper device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the quick-attach hopper device 100 as shown in the FIGS. are for illustrative purposes only, and that many other sizes and shapes of the quick-attach hopper device 100 are well within the scope of the present disclosure. Although the dimensions of the quick-attach hopper device 100 are important design parameters for user convenience, the quick-attach hopper device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A quick-attach hopper device comprising:
a hopper body comprised of an interior space formed by a sidewall and a bottom wall;
a quick-attach plate positioned on an exterior surface of the sidewall; and
a fork pocket comprised of an opening.

2. The quick-attach hopper device of claim 1, wherein the body is comprised of a stiffening angle.

3. The quick-attach hopper device of claim 1, wherein the body is comprised of a curved lip.

4. The quick-attach hopper device of claim 1, wherein the bottom wall is angled.

5. The quick-attach hopper device of claim 4, wherein the bottom wall forms an angle between 0 and 180 degrees.

6. The quick-attach hopper device of claim 1, wherein the hopper body is comprised of a safety label.

7. A quick-attach hopper device comprising:
a hopper body comprised of an interior space formed by a first sidewall, a second sidewall, a third sidewall, and a bottom wall;
a quick-attach plate positioned on an exterior surface of the sidewall; and
a fork pocket comprised of an opening.

8. The quick-attach hopper device of claim 7, wherein the exterior surface is comprised of a gusset.

9. The quick-attach hopper device of claim 7, wherein the body is comprised of a stiffening angle.

10. The quick-attach hopper device of claim 7, wherein the body is comprised of a curved lip.

11. The quick-attach hopper device of claim 7, wherein the bottom wall is angled.

12. The quick-attach hopper device of claim 11, wherein the bottom wall forms an angle between 0 and 180 degrees.

13. The quick-attach hopper device of claim 7, wherein the quick-attach plate receives a skid-steer.

14. The quick-attach hopper device of claim 7, wherein the hopper body is comprised of a safety label.

15. A method of using a quick-attach hopper device, the method comprising the following steps:
providing a quick-attach hopper device comprised of a hopper body comprised of an interior space formed by a first side wall, a second side wall, and a bottom wall, a fork pocket, and a quick-attach plate;
filling the interior space with a material;
attaching the quick-attach hopper device to a piece of machinery; and
manipulating the quick-attach hopper device via the piece of machinery such that the hopper body is tilted and the material is dumped.

16. The method of using a quick-attach hopper device of claim 15, wherein the piece of machinery is comprised of a skid steer.

17. The method of using a quick-attach hopper device of claim 16, wherein the skid steer attaches to a quick-attach plate of the quick-attach hopper device.

18. The method of using a quick-attach hopper device of claim 15, wherein the piece of machinery is comprised of a forklift.

19. The method of using a quick-attach hopper device of claim 18, wherein the forklift attaches to a forklift pocket of the quick-attach hopper device.

20. The method of using a quick-attach hopper device of claim 15, wherein the hopper body is comprised of a safety label.
